(19) United States
(12) Patent Application Publication
(10) Pub. No.: US 2007/0025193 A1
(43) Pub. Date: Feb. 1, 2007

(54) Recording medium and signal processing unit for recording medium drive

(75) Inventor: Tetsuo Hosokawa, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: FUJITSU LIMITED

(21) Appl. No.: 11/541,309

(22) Filed: Sep. 29, 2006

Related U.S. Application Data
(63) Continuation of application No. PCT/JP04/08040, filed on Jun. 9, 2004.

(51) Int. Cl. G11B 11/00

(52) U.S. Cl. 369/13.54

(57) ABSTRACT

A magnetic film is formed over phase pit sequences in a recording medium. Recording marks are established in the magnetic film in accordance with the direction of the magnetization. A laser beam is utilized to read out information from the phase pit sequences. The laser beam is also utilized to read out information based on the recording marks. The minimum mark size of the recording marks is set larger than minimum pit length in the phase pit sequences. The recording medium allows minimization of the influence of the phase pit sequences during the readout of information based on the recording marks as compared with a recording medium having the minimum pit length equal to the minimum mark size. Information can be read out based on the recording marks with a sufficient accuracy even when the minimum pit length gets smaller in the phase pit sequences.

This is a continuation of International Application No. PCT/JP2004/008040, filed Jun. 9, 2004.

### BACKGROUND OF THE INVENTION

1. Field of the Invention

The present invention relates to a recording medium including a substrate having a surface defining phase pit sequences and a magnetic film defining a recording mark on the surface of the substrate based on the direction of magnetization.

2. Description of the Prior Art

A so-called concurrent ROM-RAM magneto-optical disk is well known as disclosed in Japanese Patent Application Publication No. 6-202820, for example. RAM (Random Access Memory) information can be written anytime into a magnetic recording film formed on the surface of a substrate in the magneto-optical disk in the manner similar to a general magneto-optical disk. Phase pits have been established on the surface of the substrate. The phase pits serve to hold ROM (Read Only Memory) information.

A laser beam is irradiated onto the magneto-optical disk for the readout of the ROM information. The irradiated laser beam reflects from the magneto-optical disk at various intensities. The light intensity depends on whether a phase pit exits or not. This variation in the light intensity is utilized to read out the ROM information. A laser beam is likewise irradiated onto the magneto-optical disk for the readout of the RAM information. The polarization plane rotates in the laser beam in response to the polar Kerr effect acting from the magnetic recording film. The rotation of the polarization plane is utilized to discriminate binary data or bit data contained in the RAM information. However, the readout of the ROM information and the RAM information cannot concurrently be achieved as expected.

### SUMMARY OF THE INVENTION

It is accordingly an object of the present invention to provide a recording medium contributing to a sufficient discrimination of information for recording marks in a magnetic film even when the minimum pit length is reduced to the utmost in phase pit sequences.

According to a first aspect of the present invention, there is provided a recording medium comprising: a substrate defining phase pit sequences in the surface of the substrate, the phase pit sequences each designed to have a minimum pit length of a first length; and a magnetic film defining recording mark sequences on the surface of the substrate, the recording mark sequences each designed to have a minimum mark size of a second length larger than the first length.

The recording medium allows minimization of the influence of the phase pit sequences during the readout of information based on the recording marks as compared with a recording medium having the minimum pit length equal to the minimum mark size. Jitter can be reduced in the discrimination of the recording marks. Information can be read out based on the recording marks with a sufficient accuracy even when the minimum pit length gets smaller in the phase pit sequences. In general, when the minimum pit length is set smaller in the phase pit sequences, the optical depth of the phase pits is set larger. A larger optical depth of the phase pits causes an increase in jitter in the discrimination of the recording marks. In other words, accuracy gets deteriorated in the discrimination of the recording marks. If the minimum mark size is set larger than the minimum pit length as defined in the first aspect of the present invention, the deterioration of the accuracy can be minimized.

The minimum mark size preferably is the product of the minimum pit length and an integer. The recording medium enables generation of a clock signal based on the information read out from the phase pit sequences. The clock signal can be utilized for the recordation and reproduction of information based on the recording marks. The clock signal generated from the phase pit sequences reflects fluctuation in the speed of the movement of the phase pit sequences, so that the influence of the fluctuation in the speed of the movement can thus be eliminated in the recordation and reproduction of information based on the recording marks. This results in realization of the recordation and reproduction of information based on the recording marks with a higher accuracy.

The difference is preferably set smaller than 25 nm between first and second birefringent values in the substrate at least over an area including the phase pit sequences, the first birefringent value being measured for a single pass of an optical beam passing through the substrate of an attitude rotated by 20 degrees from a reference plane perpendicular to the optical beam around a tangent line extending through a spot of the optical beam on the substrate, the second birefringent value being measured for a single pass of the optical beam passing through the substrate of an attitude rotated by 20 degrees from the reference plane around a radial line extending through the spot of the optical beam on the substrate. The recording medium enables realization of jitter equal to or smaller than 8% in the readout of the recording marks even when the optical depth of the phase pits is set in the range from 0.14λ to 0.25λ in the phase pit sequences. Here, λ stands for the wavelength of an optical beam utilized for the readout of information.

The interval may be set in the range from 1.0 μm to 1.2 μm between the adjacent ones of the phase pit sequences. The minimum pit length may be set in the range from 0.55 μm to 0.65 μm. The set interval and minimum pit length contribute to establishment of the phase pits at a higher density. The inventor has revealed that information can be read out with a sufficient accuracy based on the phase pit sequences and the recording mark sequences even when the phase pits are arranged in a packed manner at a higher density.

The recording medium may further comprise a reflection film having a mirror surface opposed to the phase pit sequences and the recording mark sequences. In this case, the reflectance of light reflected from the mirror surface at a position off the phase pits in the phase pit sequences is set in the range from 14% to 24%. The set reflectance enables the readout of information based on the phase pit sequences and the recording mark sequences with a sufficient accuracy even when the phase pits are arranged in a packed manner at a higher density.

At least one of sonant information and image information may be recorded in the recording medium based on the utilization of the phase pit sequences. Sonant information may be recorded in the recording medium based on the utilization of the recording mark sequences. In general, a data compression method of a higher compression rate, such as MP3, can be applied to the sonant information. The sonant information of a sufficient volume can be recorded in the recording medium even when the recording mark sequences are utilized for the recordation of the sonant information. Since the density of the phase pits is higher than that of the recording marks, the image information of a sufficient volume can be recorded in the recording medium.

According to a second aspect of the present invention, there is provided a recording medium comprising: a substrate defining phase pit sequences on the surface of the substrate; and a magnetic film defining recording marks on the surface of the substrate based on the direction of magnetization, wherein the following relationship is established between the optical depth Pd[λ] of a phase pit in the phase pit sequences and the difference d[nm] between first and second birefringent values:

[Expression 1]
Pd<−0.0052d+0.253 (1)
where the first birefringent value being measured for a single pass of an optical beam passing through the substrate of an attitude rotated by 20 degrees from a reference plane perpendicular to the optical beam around a tangent line extending through a spot of the optical beam on the substrate, the second birefringent value being measured for a single pass of the optical beam passing through the substrate of an attitude rotated by 20 degrees from the reference plane around a radial line extending through the spot of the optical beam on the substrate, λ stands for the wavelength of an optical beam for the readout of information. The recording medium enables a reliable realization of jitter equal to or smaller than 8% in the readout of information based on the recording marks. This results in achievement of recordation and reproduction of information with a higher accuracy based on the recording marks.

In particular, the following relationship is preferably established in the recording medium:

[Expression 2]
Pd<−0.0052d+0.253+0.03N (2)
with a proviso

$$\begin{matrix}[ Expression 3 ] & \\ N = \frac{S}{L} ( \geq 1 ) & ( 3 )\end{matrix}$$

where L stands for a minimum pit length of the phase pit sequences, S standing for a minimum mark size of the recording marks. The recording medium enables a reliable realization of jitter equal to or smaller than 8% in the readout of information based on the recording marks even when the rate between the minimum pit length L in the phase pit sequences and the minimum mark size S of the recording marks changes.

N preferably is a natural number in the recording medium. This allows the minimum mark size to be set as the product of the minimum pit length and an integer. A clock signal generated from the phase pit sequences can be utilized for recordation and reproduction of information based on the recording marks in the same manner as described above. This results in achievement of recordation and reproduction of information with a higher accuracy based on the recording marks.

The following relationship is also preferably established in the recording medium:

[Expression 4]
Pd>0.12 (4)
The recording medium enables a reliable realization of jitter equal to or smaller than 8% in the readout of information based on the recording marks even when the minimum pit length in the phase pit sequences is set smaller than one according to the standard of a compact disk (CD).

In particular, the following relationship is preferably established in the recording medium:

[Expression 5]
Pd>0.17 (5)
When the phase pit sequences are formed in the recording medium in accordance with the standard of a compact disk, information can be read out of the recording medium with a conventional compact disk (CD) player. The recording medium is compatible to the conventional compact disk.

The optical depth of the phase pit is preferably set equal to or larger than 0.225λ. Such an optical depth enables establishment of the modulation degree equal to or larger than 60%. The standard of the compact disk can be satisfied.

The substrate may be made of a resin material in the recording medium. In particular, the substrate may preferably be made of a material belonging to amorphous polyolefin system. The birefringent difference can reliably be set smaller than 25 nm in the substrate of this type.

The interval may be set in the range from 1.0 μm to 1.2 μm between the adjacent ones of the phase pit sequences in the recording medium. Likewise, the minimum pit length may be set in the range from 0.55 μm to 0.65 μm. The set interval and minimum pit length contribute to establishment of the phase pits at a higher density. The inventor has revealed that information can be read out based on the phase pit sequences and the recording marks with a sufficient accuracy even when the phase pits are arranged in a packed manner at a higher density.

The recording medium may further comprise a reflection film having a mirror surface opposed to the phase pit sequences and the recording marks. In this case, the reflectance of light reflected from the mirror surface at a position off the phase pit in the phase pit sequences is set in the range from 14% to 24%. The set reflectance enables the readout of information based on the phase pit sequences and the recording marks with a sufficient accuracy even when the phase pits are arranged in a packed manner at a higher density.

At least one of sonant information and image information may be recorded in the recording medium based on the utilization of the phase pit sequences. Sonant information may also be recorded in the recording medium based on the utilization of the recording marks. In general, a data compression method of a higher compression rate, such as MP3, can be applied to the sonant information. The sonant information of a sufficient volume can be recorded in the recording medium even when the recording marks are utilized for the recordation of the sonant information. Since the density of the phase pits is higher than that of the recording marks, the image information of a sufficient volume can be recorded in the recording medium.

According to a third aspect of the present invention, there is provided a signal processing unit for a recording medium drive, comprising: a first signal processing circuit designed to process a signal at a clock timing of a predetermined interval, the signal being generated based on phase pit sequences on a recording medium; and a second signal processing circuit designed to process a signal at a clock timing of an interval equal to the product of the predetermined interval and an integer, the signal being generated based on a magnetic film on the phase pit sequences.

The signal processing unit enables synchronization between the processings of the first signal processing circuit and the second signal processing circuit. A common clock signal can thus be utilized for both the processings. In addition, even when a clock signal is generated based on the processing at the first signal processing circuit, the second signal processing circuit is allowed to operate based on the clock signal. These signal processing circuits significantly contribute to realization of recordation and reproduction of information based on the recording marks in the aforementioned recording medium.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a perspective view schematically illustrating a magneto-optical disk as an example of a recording medium according to the present invention;

FIG. 2 is an enlarged partial sectional view taken along the line 2-2 in FIG. 1;

FIG. 3 is an enlarged perspective view schematically illustrating the structure of the substrate of the magneto-optical disk;

FIG. 4 is a schematic view for explaining a method of measuring the birefringence;

FIG. 5 is a schematic view schematically illustrating the structure of a magneto-optical disk drive;

FIG. 6 is an enlarged partial perspective view showing the positional relationship between a phase pit sequence and the polarization plane of a laser beam;

FIG. 7 is a block diagram schematically illustrating the structure of a signal processing unit;

FIG. 8 is a graph showing the relationship between jitter and the actual and optical depths of the phase pits;

FIG. 9 is a graph showing the relationship between the optical depth of the phase pits and the modulation degree;

FIG. 10 is a graph showing the relationship between the birefringent difference and jitter;

FIG. 11 is a graph showing the relationship between the reflectance and jitter;

FIG. 12 is a graph showing the relationship between the optical depth of the phase pits and the birefringent difference;

FIG. 13 is a graph showing the relationship between the actual and optical depths of the phase pits and jitter;

FIG. 14 is a graph showing the relationship between the reflectance and jitter; and

FIG. 15 is a graph showing the optical depth of the phase pits and the birefringent difference.

### DESCRIPTION OF THE PREFERRED EMBODIMENT

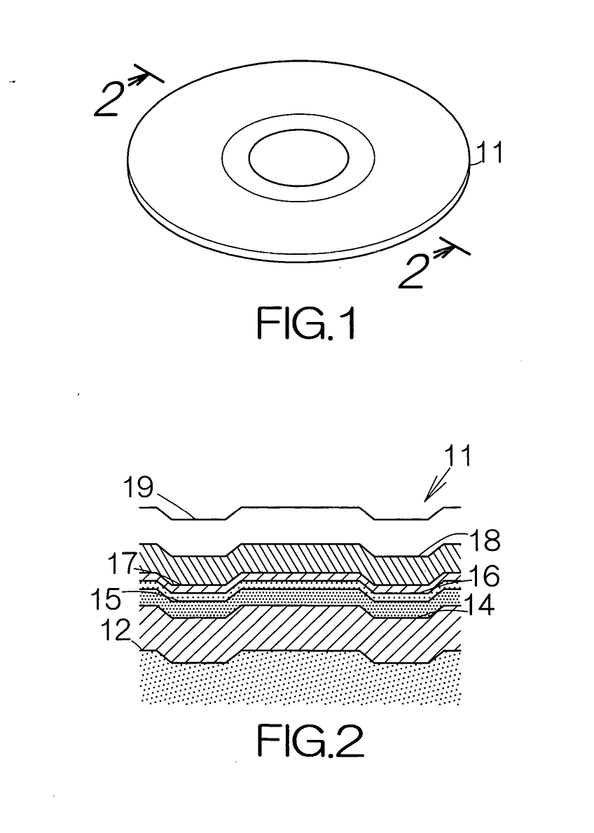

FIG. 1 illustrates a magneto-optical disk 11 as an example of a recording medium according to the present invention. The magneto-optical disk 11 is a so-called concurrent ROM-RAM magneto-optical disk. The diameter of the magneto-optical disk 11 is set at 120 mm, for example. It should be noted that such a medium might take the shape of a card or the like in place of the shape of a disk.

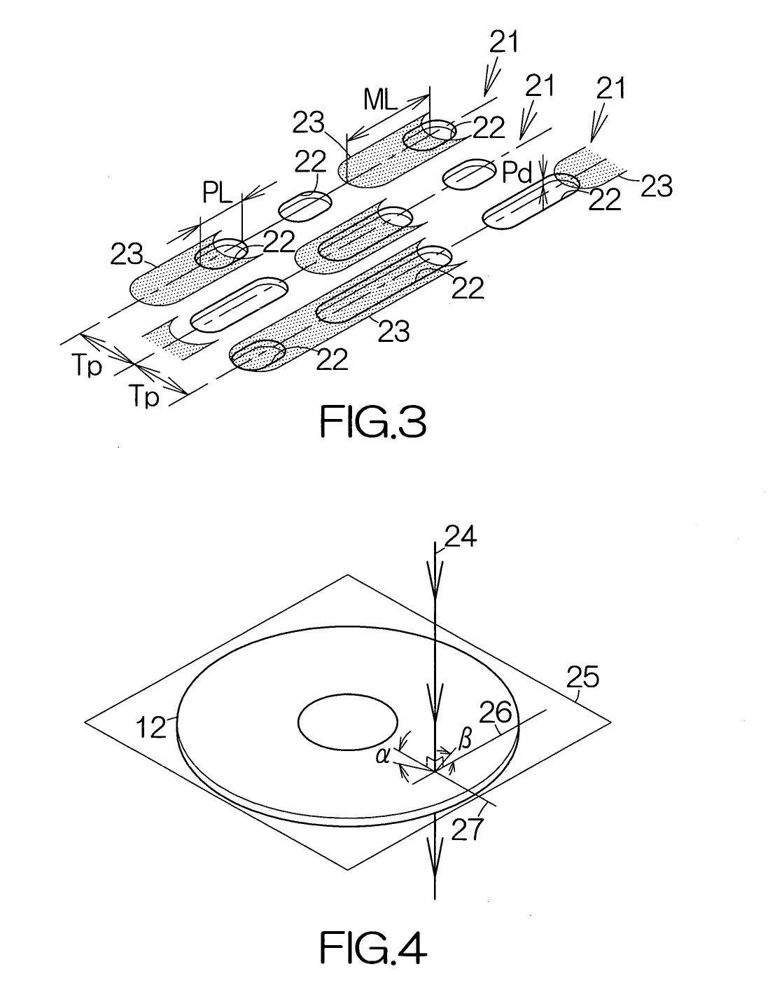

FIG. 2 schematically illustrates a sectional view of the magneto-optical disk 11. The magneto-optical disk 11 includes a substrate 12 in the shape of a disk. The substrate 12 is made of a transparent material. The transparent material may be a resin material such as polycarbonate, amorphous polyolefin, or the like. Injection molding is employed to form the substrate 12. An undercoat film 14, a magnetic recording film 15, an auxiliary magnetic film 16, an overcoat film 17, a reflection film 18 and a protection film 19 are formed on the surface of the substrate 12 in this sequence. The undercoat film 14 may be made of a transparent material such as SiN. The magnetic recording film 15 may be made of a transparent magnetic material such as TbFeCo. Likewise, the auxiliary magnetic film 16 may be made of a transparent magnetic material such as GbFeCo. The overcoat film 17 may be made of a transparent material such as SiN. The reflection film 18 may be made of a material such as aluminum capable of establishing a mirror surface. The protection film 19 may be made of a UV-curable resin material, for example.

As shown in FIG. 3, phase pit sequences 21 are formed on the surface of the substrate 12. The individual phase pit sequence 21 includes phase pits 22. The individual phase pit 22 is formed as a depression having an optical depth Pd. Each of the phase pit sequences establishes a recording track. The phase pit sequences 21 are arranged at intervals called “track pitch” Tp in the radial direction of the substrate 12. The track pitch Tp may be set in the range from 1.0 μm to 1.2 μm, for example. The minimum pit length PL may be set in the range from 0.55 μm to 0.65 μm, for example. The phase pits 22 can thus be formed in the magneto-optical disk 11 with a higher density. It should be noted that the track pitch Tp and the minimum pitch length PL may take any values in response to a change of other conditions.

The undercoat film 14, the magnetic recording film 15, the auxiliary magnetic film 16, the overcoat film 17, the reflection film 18 and the protection film 19 are formed on the entire surface of the substrate 12. The phase pit sequences 21 are thus covered with the undercoat film 14, the magnetic recording film 15, the auxiliary magnetic film 16, the overcoat film 17, the reflection film 18 and the protection film 19. Recording marks 23 are established in the magnetic recording film 15 on the phase pit sequences 21. The mirror surface of the reflection film 18 is thus opposed to the phase pit sequences 21 and the recording marks 23. In the case where the downward magnetization is established in the entire magnetic recording film 15, for example, the upward magnetization is established in the recording marks 23. Such reversal of the magnetization allows establishment of the recording marks 23. The recording marks 23 respectively have the minimum mark size ML set larger than the minimum pit length PL. Here, the minimum mark size ML of the recording marks 23 is set equal to the product of the minimum pit length PL and an integer.

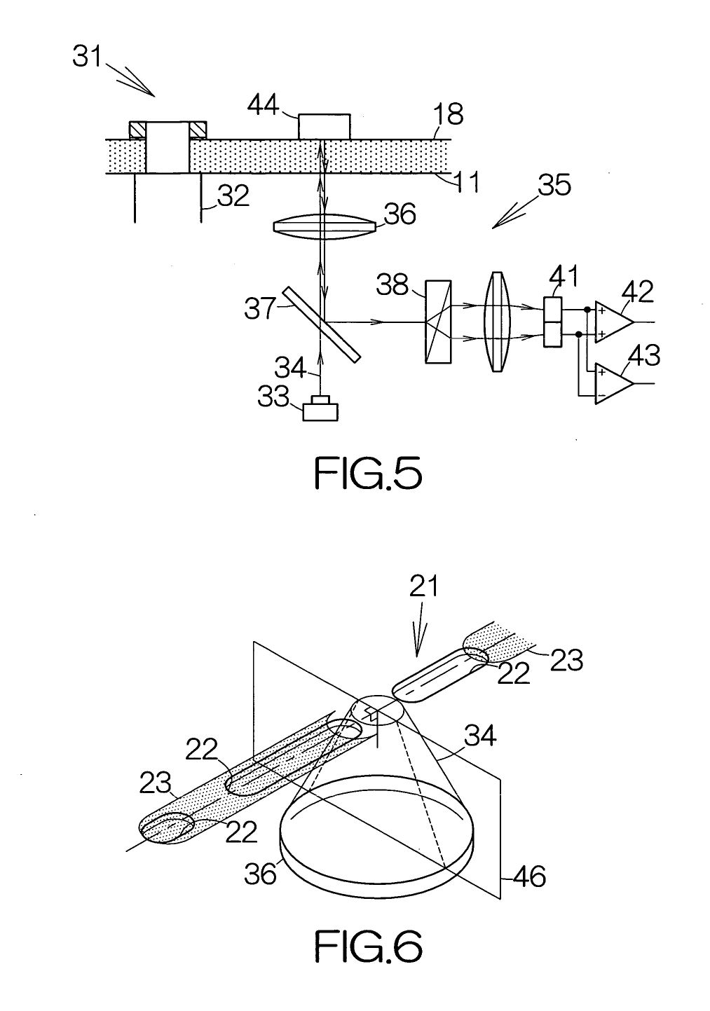

Difference is set smaller than 25 nm between first and second birefringent values in the magneto-optical disk 11. This difference is hereinafter referred to as a “birefringent difference”. In this case, a single pass of a first inclined optical beam is utilized to measure the first birefringent value of the substrate 12. A single pass of a second inclined optical beam is likewise utilized to measure the second birefringent value of the substrate 12. As shown in FIG. 4, for example, the substrate 12 is kept, for the measurement of the first birefringent value, in an attitude rotated by an inclination angle α equal to 20 degrees from a reference plane 25 perpendicular to an optical beam 24 around a tangent line 26 tangent to the phase pit sequence 21 passing through the spot of the optical beam 24 on the substrate 12. Likewise, the substrate 12 is kept, for the measurement of the second birefringent value, in an attitude rotated by an inclination angle β equal to 20 degrees from thereferenceplane 25 aroundaradial line 27 passingthrough the spot of the optical beam 24 on the substrate 12. A conventional birefringent measurement instrument such as ADR-200B®, distributed from ORC Manufacturing Co., Ltd., may be employed to measure the first and second birefringent values.

The magneto-optical disk 11 enables establishment of so-called ROM (Read Only Memory) information based on the phase pit sequences 21. A laser beam is irradiated along the phase pit sequences 21 for the readout of the ROM information. The light intensity of light reflected from the magneto-optical disk 11 varies in response to the in existence and presence of the phase pit 22. This change in the light intensity is utilized to discriminate binary data. Here, the ROM information corresponds to image information recorded in the magneto-optical disk 11. A data compression method such as MPEG may be employed to reduce the volume of the image information. The magneto-optical disk 11 likewise enables establishment of so-called RAM (Random Access Memory) information based on the recording marks 23. A laser beam is irradiated along the phase pit sequences 21 for the readout of the RAM information. The polarization plane of the laser beam rotates in response to the polar Kerr effect of the magnetic recording film 15. This rotation of the polarization plane is utilized to discriminate binary data. A laser beam is irradiated on the magnetic recording film 15 along the phase pit sequences 21 for the recordation of the RAM information. A magnetic field is simultaneously applied to the magnetic recording film 15 at a predetermined intensity. Magnetization is established in a specific direction in response to a rise in the temperature of the magnetic recording film 15 and reversal of the magnetic field. Here, the RAM information corresponds to sonant information recorded in the magneto-optical disk 11. A data compression method such as MP3 may be employed to reduce the volume of the sonant information.

Next, a brief description will be made on a method of making the magneto-optical disk 11. The substrate 12 is first molded. An injection molding machine is utilized, for example. Fluid such as fluid polycarbonate, fluid polyolefin, or the like, is poured into a mold or stamper. The stamper serves to form the phase pits 22 on the surface of the substrate 12. The thickness of the substrate 12 is set at 1.2 mm, for example. When polycarbonate is employed as the material of the substrate 12, the substrate 12 may be subjected to annealing treatment after the injection molding. The annealing treatment contributes to a reduction in the birefringent difference of the substrate 12. The temperature of the annealing treatment is preferably set equal to or lower than 120 degrees Celsius. The temperature higher than 120 degrees Celsius causes a large change in the properties of the substrate 12. It should be noted that any method different from the described one may be employed to form the substrate 12.

The undercoat film 14, the magnetic recording film 15, the auxiliary magnetic film 16, the overcoat film 17, the reflection film 18 and the protection film 19 are thereafter sequentially formed on the surface of the substrate 12. Sputtering is employed to form the films 14-19, for example. A vacuum equal to or smaller than 5×e⁻⁵[Pa] is set in each chamber of a sputtering apparatus.

The substrate 12 is first transported into a first chamber. A Si target is set in the first chamber. Ar gas and N₂ gas are introduced into the first chamber. Reactive sputtering is effected in the first chamber to form a SiN film or undercoat film 14. The thickness of the SiN film is set at 80.0 nm approximately, for example.

The substrate 12 is then transported into a second chamber. The magnetic recording film 15 and the auxiliary magnetic film 16 are sequentially formed on the surface of the substrate 12 in the second chamber. Here, the magnetic recording film 15 is made of a Tb₂₂(Fe₈₈Co₁₂)₇₈ alloy film having the thickness of 30.0 nm approximately, for example. The auxiliary magnetic film 16 is made of a Gd₁₉(Fe₈₀Co₂₀)₈₁ alloy film having the thickness of 4.0 nm approximately, for example.

The substrate 12 is again transported into the first chamber. The overcoat film 17 and the reflection film 18 are sequentially formed on the surface of the auxiliary magnetic film 16. The overcoat film 17 is made of a SiN film having the thickness of 5.0 nm approximately, for example. The reflection film 18 is made of an aluminum film having the thickness of 50.0 nm approximately, for example. The protection film 19 is formed on the reflection film 18. The protection film 19 may be made of a UV-curable resin coat, for example. The magneto-optical disk 11 is in this manner formed. It should be noted that the materials may be selected from any general materials suitable for a recording medium for optical magnetic recording in place of the described ones.

A magneto-optical disk drive 31 is employed to effect recording/reproducing operations on the magneto-optical disk 11. The magneto-optical disk drive 31 includes a spindle 32 designed to support the magneto-optical disk 11, as shown in FIG. 5, for example. The spindle 32 serves to drive the magneto-optical disk 11 for rotation around the longitudinal axis of the spindle 32.

The magneto-optical disk drive 31 includes a light source or semiconductor laser diode 33. The semiconductor laser diode 33 is designed to emit an optical beam of the linear polarization, namely a laser beam 34. When the magneto-optical disk 11 is set on the spindle 32, a so-called optical system 35 serves to direct the laser beam 34 to the magneto-optical disk 11.

The optical system 35 includes an objective lens 36 opposed to the surface of the magneto-optical disk 11, for example. A beam splitter 37 is located between the semiconductor laser diode 33 and the objective lens 36, for example. The laser beam 34 from the semiconductor laser diode 33 passes through the beam splitter 37. The laser beam 34 is then irradiated onto the magneto-optical disk 11 through the objective lens 36. The objective lens 36 serves to form a minute beam spot on the surface of the magneto-optical disk 11. The laser beam 34 passes through the substrate 12, the undercoat film 14, the magnetic recording film 15, the auxiliary magnetic film 16 and the overcoat film 17. The laser beam 34 finally reaches the reflection film 18. The reflection film 18 reflects the laser beam 34. The reflected laser beam 34 is directed to the beam splitter 37 through the objective lens 36.

A two-beam Wollaston 38 is opposed to the beam splitter 37. The beam splitter 37 serves to reflect the laser beam 34 returning from the magneto-optical disk 11. The laser beam 34 is directed to the two-beam Wollaston 38 through the beam splitter 37. The two-beam Wollaston 38 splits the laser beam 34 into two beams having the polarization planes perpendicular to each other.

A bisected photodetector 41 is placed behind the two-beam Wollaston 38. The bisected photodetector 41 is designed to detect the laser beam 34 for each polarization plane after the split at the two-beam Wollaston 38. The laser beam 34 is converted into an electric signal for each polarization plane. The electric signals for the polarization planes are then summed at a summing amplifier 42. The intensity is detected for the overall laser beam 34. The ROM information is in this manner read out based on the output from the summing amplifier 42. The electric signals are also subjected to subtraction at a subtracting amplifier 43. The rotation is detected between the polarization plane of the laser beam 34 reflecting from the magneto-optical disk 11 and the polarization plane of the laser beam 34 before the reflection. The RAM information is in this manner read out based on the output from the subtracting amplifier 43.

A magnetic head slider 44 is opposed to the objective lens 36. An electromagnetic transducer is mounted on the magnetic head slider 44. The electromagnetic transducer may be located on the extension of the path of the laser beam 34 directed from the objective lens 36 to the magneto-optical disk 11. The irradiation of the laser beam 34 causes a rise in the temperature of the magnetic recording film 15. The electromagnetic transducer serves to apply a magnetic field for recordation to the magnetic recording film 15. The rise in the temperature allows the magnetization to rotate in the magnetic recording film 15 in response to the direction of the magnetic field for recordation. The RAM information is in this manner written into the magnetic recording film 15. It should be noted that a so-called optical modulation recording may be employed in place of the magnetic modulation recording as described.

As shown in FIG. 6, the polarization plane 46 of the laser beam 34 is set perpendicular to the phase pit sequence 21 in the magneto-optical disk drive 31. In other words, the laser beam 34 of a so-called perpendicular polarization is applied to the phase pits 22 and the magnetic recording film 15. The laser beam 34 of the perpendicular polarization contributes to a reduction in jitter in the readout of the ROM and RAM information.

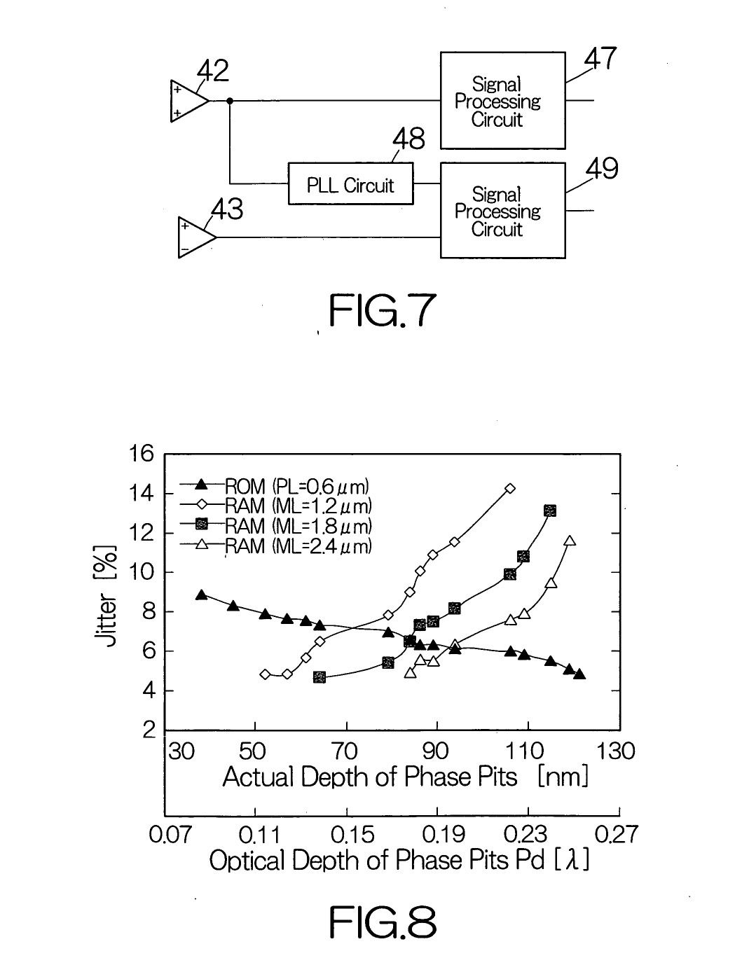

As shown in FIG. 7, the output from the summing amplifier 42 is supplied to a signal processing circuit 47 for the readout of the ROM information, for example. The output from the summing amplifier 42 is also supplied to a PLL (phase-locked loop) circuit 48. The PLL circuit 48 generates a clock signal based on the data string of the ROM information supplied from the summing amplifier 42. The clock signal is supplied to a signal processing circuit 49. The output from the subtracting amplifier 43 is also supplied to the signal processing circuit 49. The signal processing circuit 49 is designed to detect binary date in the output from the subtracting amplifier 43 in synchronization with the clock signal from the PLL circuit 48. The minimum mark size ML of the recording mark 23 is the product of the minimum pit length PL of the phase pit 22 and an integer, so that the binary date can reliably be read out from the recording marks 23, as long as the recording marks 23 are established in synchronization with the clock signal. The clock signal from the PLL circuit 48 follows the fluctuation of the rotation of the magneto-optical disk 11. The influence of the fluctuation can thus significantly be eliminated when the recording marks 23 are to be read/written.

The inventor has observed the properties of the magneto-optical disk 11. The substrates 12 were prepared. The phase pit sequences 21 were formed on each of the substrates 12 based on the eight to fourteen modulation (EFM). The track pitch Tp was set at 1.1 μm. The width of the phase pits 22 was set at 0.55 μm. The minimum pit length PL was set at 0.60 μm. The actual depth of the phase pits 22 was individually set for The substrates 12 in the range from 38.0 nm to 121.0 nm. The actual depth was adjusted by changing the thickness of the resist resin applied in the process of forming the stamper, by changing the exposure period of the deep-ultraviolet irradiated onto the molded substrates 12, and the like, for example. The ROM information is in this manner established based on the phase pit sequences 21.

The first substrate 12 was made of polycarbonate known as Panlite® ST-3000 distributed from Teijin Chemicals Limited. The annealing treatment was omitted after the injection molding. The first substrate 12 was allowed to have the birefringent difference equal to 43 nm. The second and third substrates 12 were likewise made of polycarbonate. The annealing treatment was effected on the substrates 12 for a period of one hour after the injection molding. The second substrate 12 was subjected to the annealing treatment at the temperature of 100 degrees Celsius. The second substrate 12 was allowed to have the birefringent difference equal to 34 nm. The third substrate 12 was subjected to the annealing treatment at the temperature of 120 degrees Celsius. The third substrate 12 was allowed to have the birefringent difference equal to 25 nm. The fourth substrate 12 was made of amorphous polyolefin known as Arton® D4810 distributed from JSR Corporation. The annealing treatment was omitted after the injection molding. The fourth substrate 12 was allowed to have the birefringent difference equal to 17 nm irrespective of the omission of the heat treatment. The inventor also prepared the fifth substrate 12 made of amorphous polyolefin known as ZEONEX® E28R distributed from ZEON Corporation. The annealing treatment was omitted after the injection molding. The fifth substrate 12 was allowed to have the birefringent difference equal to 10 nm approximately irrespective of the omission of the heat treatment. ADR-200B®, distributed from ORC Manufacturing Co., Ltd., was utilized for the measurement of the birefringent difference. The wavelength of the laser beam was set at 635 nm.

The inventor prepared the magneto-optical disks 11 based on the first to fourth substrates 12, respectively. The recording marks 23 were established in the magnetic recording film 15 based on the eight to fourteen modulation (EFM) in each of the magneto-optical disks 11. Magnetic field modulation recording was utilized. The wavelength λ of the laser beam was set at 650 nm. The numerical aperture NA of the objective lens was set at 0.55. The set wavelength λ and numerical aperture NA allow the laser beam to form a spot, having the spot diameter of 1.1 μm approximately, on the surface of the magnetic recording film 15 at the intensity of 1/e². The linear velocity was set at 4.8 [μm/s]. The minimum mark size ML of 1.2 μm, 1.8 μm or 2.4 μm was selectively set for the individual magneto-optical disk 11. Adjustment was effected on the control of clock timing and the control of the laser beam so as to set the minimum mark size ML. The reflectance was set at 19% approximately for all the magneto-optical disks 11. Here, the inventor measured the reflectance of the laser beam reflected from the mirror surface of the reflection film 18 at a position off the phase pits 22. The RAM information was in this manner established based on the recording marks 23.

The ROM information was then read out from the phase pit sequences 21 of the magneto-optical disk 11. Jitter or ROM jitter was measured based on the obtained ROM information. The RAN information was also read out from the recording marks 23. Jitter or RAM jitter was measured based on the obtained RAM information. The wavelength λ of the laser beam was set at 650 nm in the same manner as the recordation of the information. The numerical aperture NA of the objective lens was set at 0.55. The linear velocity was set at 4.8 [μm/s]. The polarization plane of the laser beam was set in the direction perpendicular to the phase pit sequences 21 or the direction of tracking.

As is apparent from FIG. 8, when the optical depth Pd of the phase pits 22 gets larger, the ROM jitter decreases. When the optical depth Pd of the phase pits 22 gets larger, the RAM jitter increases. The larger the minimum mark size ML of the recording marks 23 gets, the less influence of the increase in the optical depth Pd the RAM jitter is subjected to. In other words, an increase in the minimum mark size ML of the recording marks 23 enables a sufficient reduction of jitter [%] even when the optical depth Pd of the phase pits 22 is set relatively large. In general, jitter equal to or smaller than 10% is required for recordation and reproduction of images and sound including music. Jitter equal to or smaller than 8% is required for recordation and reproduction of character and numeric data. Here, the magneto-optical disk 11 including the fourth substrate was employed for the measurement of the ROM jitter and the RAM jitter.

The optical depth Pd of the phase pits 22 is preferably set in a range from 0.14λ to 0.25λ in the magneto-optical disks 11. As is apparent from FIG. 9, such an optical depth Pd contributes to realization of the modulation degree in a range from 35% to 65%. The modulation degree equal to or larger than 35% enables readout of the ROM information with a sufficient accuracy. Here, the larger the optical depth Pd gets, the smaller the minimum pit length PL of the phase pits 22 becomes. The reduction in the minimum pit length PL significantly contributes to a higher density of the ROM information. Here, the magneto-optical disk 11 including the fourth substrate was employed for the measurement of the ROM jitter and the RAM jitter in the same manner as described above.

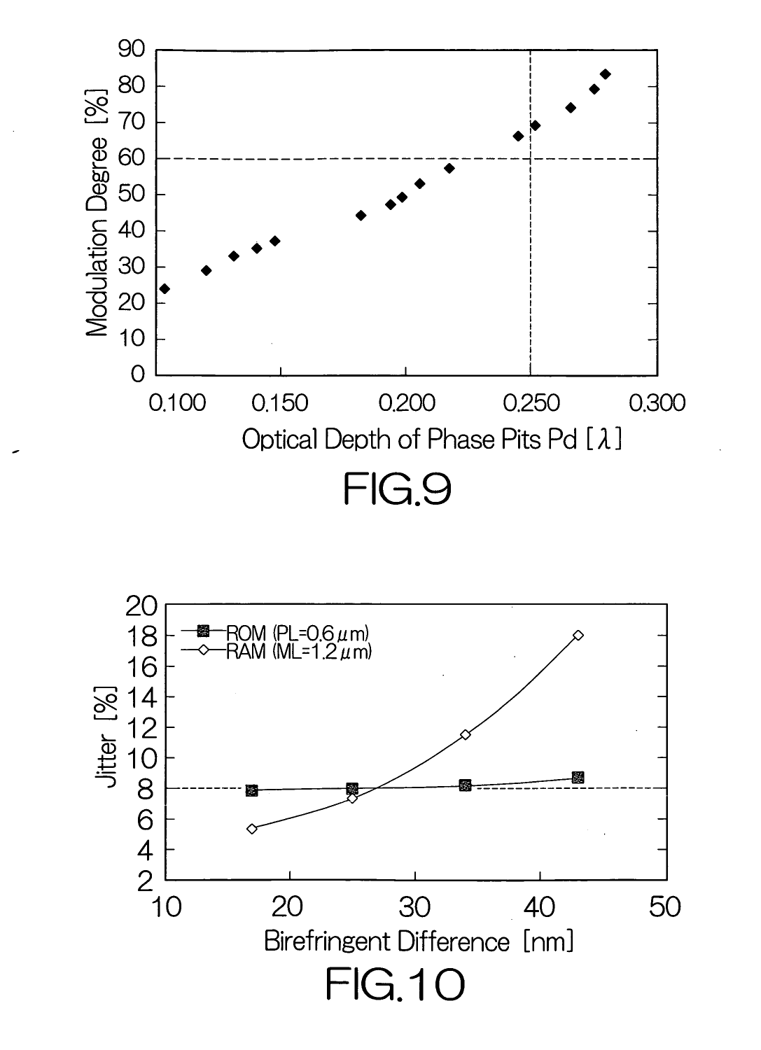

FIG. 10 is a graph showing the relationships between the birefringent difference and the ROM jitter as well as between the birefringent difference and the RAM jitter. Here, the recording marks 23 having the minimum mark size ML of 1.2 μm was employed for the measurement of the RAM jitter. The optical depth Pd of the phase pits 22 was set at 0.141λ. As is apparent from FIG. 10, the birefringent difference smaller than 25 nm enables establishment of the jitter equal to or smaller than 8%. Specifically, even when the optical depth Pd of the phase pits 22 is set equal to or larger than 0.14λ, the birefringent difference smaller than 25 nm enables realization of the jitter equal to or smaller than 8%.

FIG. 11 is a graph showing the relationships between the reflectance and the ROM jitter as well as between the reflectance and the RAM jitter. Here, the recording marks 23 having the minimum mark size ML of 1.2 μm was employed for the measurement of the RAM jitter. The optical depth Pd of the phase pits 22 was set at 0.182λ. As is apparent from FIG. 11, when the reflectance gets larger, the ROM jitter decreases. When the reflectance gets larger, the RAM jitter increases. In this case, it has been confirmed that the reflectance of 19% approximately enables a simultaneous establishment of an improved ROM jitter and an improved RAM jitter. It should be noted that the reflectance was adjusted based on the thickness of the undercoat film 14 and/or the amount of N₂ in the process of forming the undercoat film 14. Here, the inventor measured the reflectance of the laser beam reflected from the mirror surface of the reflection film 18 at a position off the phase pits 22.

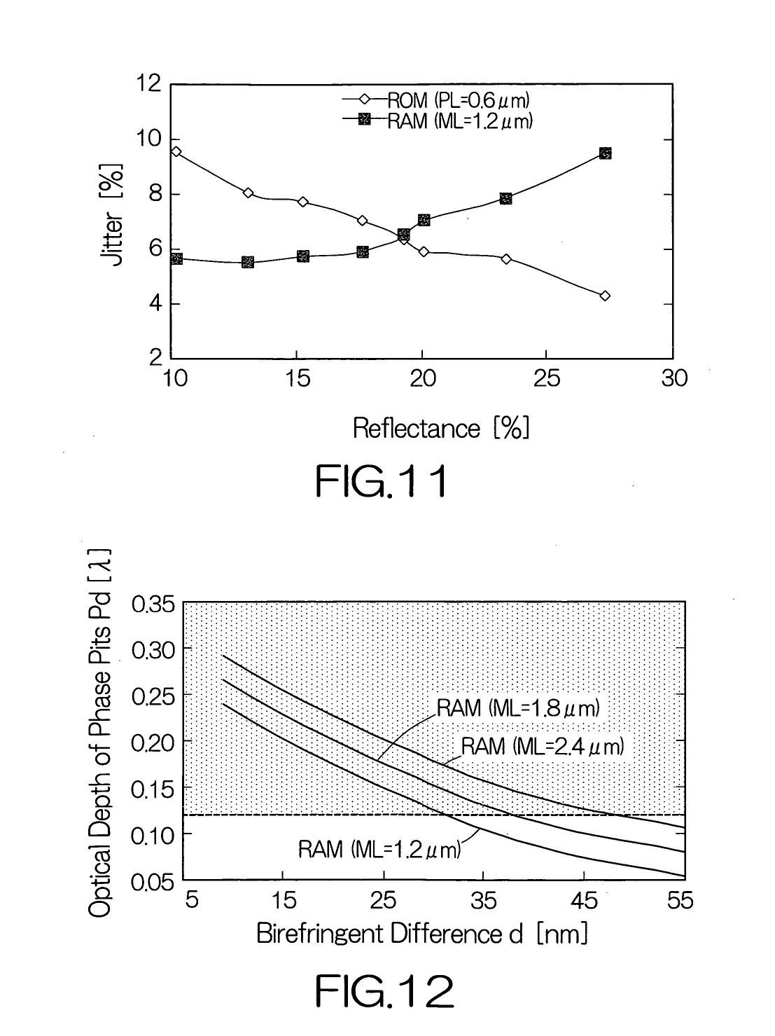

FIG. 12 is a graph showing the relationship between the optical depth Pd of the phase pits 22 and the birefringent difference. The dotted line in FIG. 12 stands for the minimum value[λ] of the optical depth Pd required to obtain the ROM jitter equal to or smaller than 8%. If the optical depth Pd falls below the value of the dotted line, the ROM jitter exceeds 8%. The optical depth Pd equal to or larger than 0.12λ enables establishment of the ROM jitter equal to or smaller than 8% irrespective of the amount of the birefringent difference and/or the length of the minimum mark size ML. The solid line in FIG. 12 stands for the maximum value[ ] of the optical depth Pd required to obtain the RAM jitter equal to or smaller than 8%. If the optical depth Pd exceeds the value of the solid line, the RAM jitter exceeds 8%. The following relationship is established between the optical depth Pd[λ] and the birefringent difference d[nm] in this observation of the RAM jitter:

[Expression 6]
Pd<−0.0052d+0.253+0.03N (2)
with a proviso

$$\begin{matrix}[ Expression 7 ] & \\ N = \frac{S}{L} ( \geq 1 ) & ( 3 )\end{matrix}$$

Here, the variable “L” stands for the minimum pit length PL of the phase pits 22. The variable “S” stands for the minimum mark size ML of the recording marks 23.

Next, the inventor further prepared the substrates 12. The phase pit sequences 21 were formed on each of the substrates 12 based on the eight to fourteen modulation (EFM). The track pitch Tp was set at 1.6 μm. The minimum pit length PL was set at 0.833 μm. Specifically, the phase pit sequences 21 were formed in accordance with the standard of a compact disk (CD). Predetermined contents were written onto each of the magneto-optical disks 11 based on the phase pit sequences 21. The actual depth of the phase pits 22 was individually set for the substrates 12 in the range from 38.0 nm to 121.0 nm. The birefringent difference of the substrates 12 was set at 17 nm.

The inventor prepared the magneto-optical disks 11 based on the aforementioned substrates 12, respectively. The recording marks 23 were established in the magnetic recording film 15 based on the eight to fourteen modulation (EFM) in each of the magneto-optical disks 11. The RAM information was established in the same manner as described above. The minimum mark size ML was set at either 1.666 μm or 2.499 μm in the individual magneto-optical disk 11. The reflectance was selectively set in the range from 10.2% to 27.3%.

The ROM jitter and the RAM jitter were measured for the magneto-optical disks 11 in the aforementioned manner. In this case, the wavelength λ of the laser beam was set at 780 nm. As is apparent from FIG. 13, it has been confirmed that an increase in the minimum mark size ML of the recording marks 23 enables a sufficient reduction of jitter [%] even when the optical depth Pd of the phase pits 22 is set relatively large.

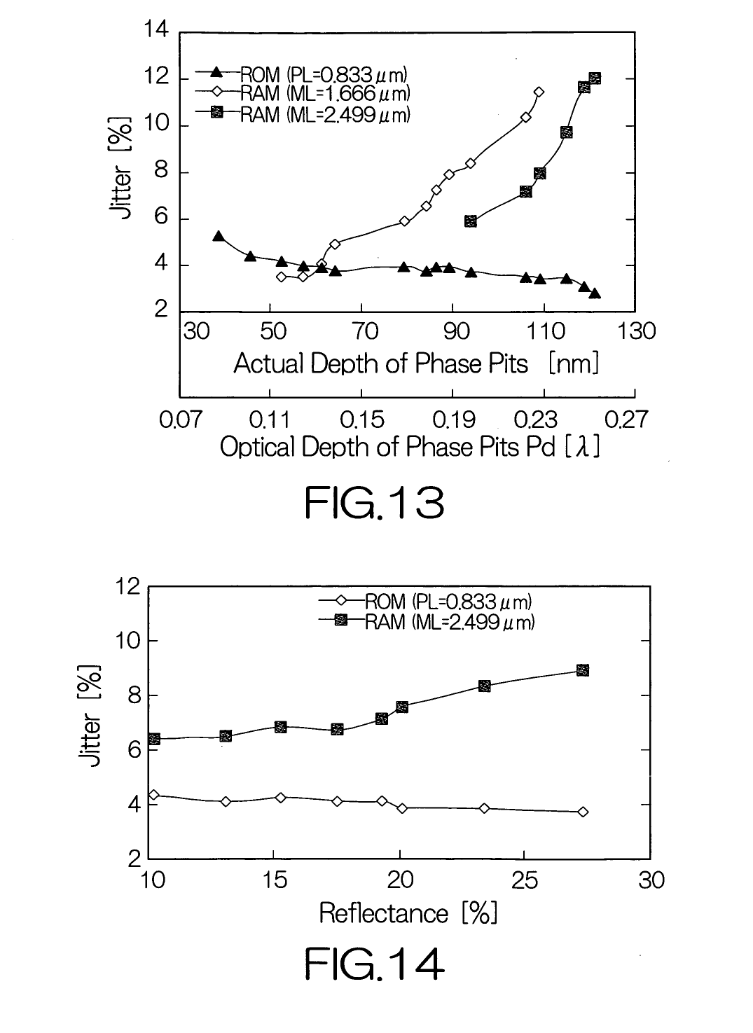

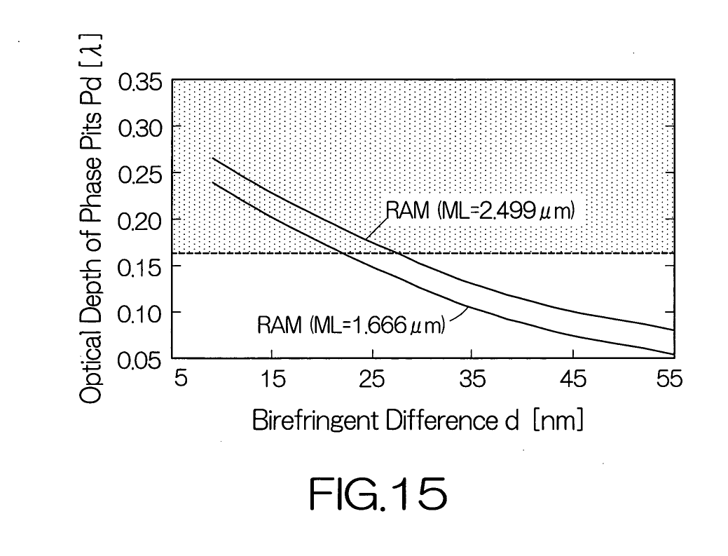

FIG. 14 is a graph showing the relationships between the reflectance and the ROM jitter as well as between the reflectance and the RAM jitter. Here, the recording marks 23 having the minimum mark size of 2.499 μm was employed for the measurement of the RAM jitter. The optical depth Pd of the phase pits 22 was set at 0.217λ. As is apparent from FIG. 14, when the reflectance gets larger, the ROM jitter decreases. When the reflectance gets larger, the RAM jitter increases. It has been confirmed that the reflectance smaller than 24% enables a simultaneous establishment of an improved ROM jitter and an improved RAM jitter. Here, the inventor measured the reflectance of the laser beam reflected from the mirror surface of the reflection film 18 at a position off the phase pits 22.

The inventor tried reproducing the aforementioned magneto-optical disks 11 with a commercially available CD-ROM player. The reflectance below 13% caused a failure in reproduction of the aforementioned contents. It has been confirmed that the reflectance in the range from 14% to 24% enables a reliable reproduction of the contents on the magneto-optical disks 11. In this case, the optical depth Pd of the phase pits 22 was set at 0.217λ in the magneto-optical disks 11.

The inventor likewise tried reproducing the aforementioned magneto-optical disks 11 with a commercially available CD-ROM player in the same manner as described above. Here, the reflectance was set at 19.3%. The inventor prepared the magneto-optical disks 11 including the phase pits 22 of various optical depths Pd. It has been confirmed that the phase pits 22 having the actual depth in the range from 121.0 nm to 86.0 nm, namely the optical depth Pd in the range from 0.279λ to 0.170λ, enables a reliable reproduction of the contents from the magneto-optical disks 11 based on the phase pit sequences 21. The optical depth Pd below 0.170λ caused a failure in the reproduction of the aforementioned contents. It should be noted that the optical depth Pd of the phase pits 22 is preferably set equal to or larger than 0.225λ. As is apparent from FIG. 9, the optical depth Pd equal to or larger than 0.225λ enables a reliable establishment of the modulation degree equal to or larger than 60% in accordance with the standard of a compact disk.

FIG. 15 is a graph showing the relationship between the optical depth Pd of the phase pits 22 and the birefringent difference. The dotted line in FIG. 15 stands for the minimum value[λ] of the optical depth Pd required for a reliable reproduction of the contents. The optical depth Pd equal to or larger than 0.17λ enables a reliable reproduction of the contents with a conventional CD player irrespective of the amount of the birefringent difference and/or the length of the minimum mark size ML. The solid line in FIG. 15 stands for the maximum value[λ] of the optical depth Pd required to obtain the RAM jitter equal to or smaller than 8%. The following relationship is established between the optical depth Pd[λ] and the birefringent difference d[nm] in this observation of the RAM jitter:

[Expression 8]
Pd<−0.0052d+0.253+0.03N (2)
with a proviso

$$\begin{matrix}[ Expression 9 ] & \\ N = \frac{S}{L} ( \geq 1 ) & ( 3 )\end{matrix}$$

Here, the variable “L” stands for the minimum pit length PL of the phase pits 22. The variable “S” stands for the minimum mark size ML of the recording marks 23.

As long as the aforementioned correlations are established between the spot diameter of the laser beam and the minimum pitch length PL as well as between the spot diameter and the track pitch Tp, the relationships shown in all the graphs are established. For example, the spot diameter of the laser beam is proportional to the wavelength λ of the laser beam while the spot diameter of the laser beam is inversely proportional to the numerical aperture NA. If the track pitch Tp is set in the range from 1.0×0.55/0.60 [μm] to 1.2×0.55/0.60 [μm], the relationships shown in all the graphs are established, even if the numerical aperture NA is changed from 0.55 to 0.60. The minimum pit length PL may be set in the range from 0.55×0.55/0.60[μm] to 0.65×0.55/0.60 [μm]. The similar idea can also be applied to the wavelength λ. Any of the described relationships is maintained in the same manner irrespective of any change in the birefringence of the substrate 12.

What is claimed is:

1. A recording medium comprising:
a substrate defining phase pit sequences in a surface of the substrate, said phase pit sequences each designed to have a minimum pit length of a first length; and
a magnetic film defining recording mark sequences on the surface of the substrate, said recording mark sequences each designed to have a minimum mark size of a second length larger than the first length.

2. The recording medium according to claim 1, wherein the minimum mark size is a product of the minimum pit length and an integer.

3. The recording medium according to claim 1, wherein a difference is set smaller than 25 nm between first and second birefringent values in the substrate at least over an area including the phase pit sequences, said first birefringent value being measured for a single pass of an optical beam passing through the substrate of an attitude rotated by 20 degrees from a reference plane perpendicular to the optical beam around a tangent line extending through a spot of the optical beam on the substrate, said second birefringent value being measured for a single pass of the optical beam passing through the substrate of an attitude rotated by 20 degrees from the reference plane around a radial line extending through the spot of the optical beam on the substrate.

4. The recording medium according to claim 1, wherein an optical depth of a phase pit is set in a range from 0.14λ to 0.25λ in the phase pit sequences where λ stands for a wavelength of an optical beam utilized for readout of information.

5. The recording medium according to claim 1, wherein an interval is set in a range from 1.0 μm to 1.2 μm between adjacent ones of the phase pit sequences, the minimum pit length being set in a range from 0.55 μm to 0.65 μm.

6. The recording medium according to claim 1, further comprising a reflection film having a mirror surface opposed to the phase pit sequences and the recording mark sequences, wherein a reflectance of light reflected from the mirror surface at a position off phase pits in the phase pit sequences is set in a range from 14% to 24%.

7. The recording medium according to claim 1, wherein at least one of sonant information and image information is recorded based on utilization of the phase pit sequences, sonant information being recorded based on utilization of the recording mark sequences.

8. A recording medium comprising:
a substrate defining phase pit sequences on a surface of the substrate; and
a magnetic film defining recording marks on the surface of the substrate based on a direction of magnetization, wherein a following relationship is established between an optical depth Pd[λ] of a phase pit in the phase pit sequences and a difference d[nm] between first and second birefringent values:
[Expression 10]
Pd<−0.0052d+0.253 (1)
where said first birefringent value being measured for a single pass of an optical beam passing through the substrate of an attitude rotated by 20 degrees from a reference plane perpendicular to the optical beam around a tangent line extending through a spot of the optical beam on the substrate, said second birefringent value being measured for a single pass of the optical beam passing through the substrate of an attitude rotated by 20 degrees from the reference plane around a radial line extending through the spot of the optical beam on the substrate, λ stands for a wavelength of an optical beam for readout of information.

9. The recording medium according to claim 8, wherein a following relationship is established:
[Expression 11]
Pd<−0.0052d+0.253+0.03N (2)
with a proviso
$$\begin{matrix}[ Expression 12 ] & \\ N = \frac{S}{L} ( \geq 1 ) & ( 3 )\end{matrix}$$
where L stands for a minimum pit length of the phase pit sequences, S standing for a minimum mark size of the recording marks.

10. The recording medium according to claim 9, wherein N is a natural number.

11. The recording medium according to claim 9, wherein a following relationship is established:
[Expression 13]
Pd>0.12 (4)

12. The recording medium according to claim 11 wherein a following relationship is established:
[Expression 14]
Pd>0.17 (5)

13. The recording medium according to claim 12, wherein the optical depth of the phase pit is set equal to or larger than 0.225λ.

14. The recording medium according to claim 13, wherein a modulation degree is set equal to or larger than 60%.

15. The recording medium according to claim 9, wherein the substrate is made of a resin material.

16. The recording medium according to claim 15, wherein the substrate is made of a material belonging to amorphous polyolefin system.

17. The recording medium according to claim 9, wherein an interval is set in a range from 1.0 μm to 1.2 μm between adjacent ones of the phase pit sequences, the minimum pit length being set in a range from 0.55 μm to 0.65 μm.

18. The recording medium according to claim 9, further comprising a reflection film having a mirror surface opposed to the phase pit sequences and the recording marks, wherein a reflectance of light reflected from the mirror surface at a position off the phase pit in the phase pit sequences is set in a range from 14% to 24%.

19. The recording medium according to claim 9, wherein at least one of sonant information and image information is recorded based on utilization of the phase pit sequences, sonant information being recorded based on utilization of the recording marks.

20. A signal processing unit for a recording medium drive, comprising:
a first signal processing circuit designed to process a signal at a clock timing of a predetermined interval, said signal being generated based on phase pit sequences on a recording medium; and
a second signal processing circuit designed to process a signal at a clock timing of an interval equal to a product of the predetermined interval and an integer, said signal being generated based on a magnetic film on the phase pit sequences.
